(19) United States
(12) Patent Application Publication
(10) Pub. No.: US 2017/0255633 A1
(43) Pub. Date: Sep. 7, 2017

(54) SYSTEM AND METHOD FOR SEARCHING BASED ON INPUT MULTIMEDIA CONTENT ELEMENTS

(71) Applicant: Cortica, Ltd., Tel Aviv (IL)

(72) Inventors: Igal Raichelgauz, Tel Aviv (IL); Karina Odinaev, Tel Aviv (IL); Yehoshua Y. Zeevi, Haifa (IL)

(73) Assignee: Cortica, Ltd., TEL AVIV (IL)

(21) Appl. No.: 15/602,770

(22) Filed: May 23, 2017

Related U.S. Application Data
(63) Continuation-in-part of application No. 15/474,019, filed on Mar. 30, 2017.
Application No. 15/474,019 is a continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/340,424, filed on May 23, 2016.
(60) Provisional application No. 62/316,603, filed on Apr. 1, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04H 60/46; H04H 60/66; H04N 7/173; H04N 21/258; H04N 21/2668; H04N 21/466; H04N 21/81; H04H 20/26; H04H 60/37; H04H 60/56; H04H 20/10; H04L 29/08

(52) U.S. Cl. CPC G06F 17/30056; H04H 20/103; H04H 60/46; H04H 60/66; H04N 7/17318; H04N 21/25891; H04N 21/2668; H04L 67/10; H04N 21/8106; H04H 20/26; H04H 60/37; H04H 60/56; H04N 21/466

(57) ABSTRACT

A system and method for searching based on input multimedia content elements. The method includes obtaining at least one signature for each of at least one input multimedia content element, each signature representing a concept, wherein each concept is a collection of signatures and metadata representing the concept; determining, based on the obtained signatures, at least one context of the at least one input multimedia content element; generating, based on the determined at least one context, at least one query; and searching in at least one data source using the generated at least one query.

### CROSS-REFERENCE TO RELATED APPLICATIONS

This application claims the benefit of U.S. Provisional Application No. 62/340,424 filed on May 23, 2016. This application is also a continuation-in-part of U.S. patent application Ser. No. 15/474,019 filed on Mar. 30, 2017, now pending, which claims the benefit of U.S. Provisional Application No. 62/316,603 filed on Apr. 1, 2016. The Ser. No. 15/474,019 Application is also a continuation-in-part of U.S. patent application Ser. No. 13/770,603 filed on Feb. 19, 2013, now pending, which is a continuation-in-part (CIP) of U.S. patent application Ser. No. 13/624,397 filed on Sep. 21, 2012, now U.S. Pat. No. 9,191,626. The Ser. No. 13/624,397 Application is a CIP of:
(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;
(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and
(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to contextual analysis of multimedia content elements, and more specifically to providing queries to search engines based on multimedia content element context.

### BACKGROUND

Since the advent of digital photography and, in particular, after the rise of social networks, the Internet has become inundated with uploaded images, videos, and other content.

To find content online, web search engines are used. Users seeking content via search engines submit queries indicating the types, subject matter, and/or sources of desired content. Search queries may be or may include text, images, and the like. Typically, search queries based on images provide web pages displaying the exact query images.

Users of the web from with different backgrounds, locations, and experiences often naturally tend to enter different search queries even when searching for the same content. As a result, the task of finding relevant and appropriate content has become increasingly complex. Further, users may have difficulty expressing the objective of a search so as to obtain accurate search results.

It would be therefore advantageous to provide a solution for accurately recommending tags that matches the multimedia content elements.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for searching based on input multimedia content elements. The method comprises: obtaining at least one signature for each of at least one input multimedia content element, each signature representing a concept, wherein each concept is a collection of signatures and metadata representing the concept; determining, based on the obtained signatures, at least one context of the at least one input multimedia content element; generating, based on the determined at least one context, at least one query; and searching in at least one data source using the generated at least one query.

Certain embodiments disclosed herein also include a non-transitory computer readable medium having stored thereon causing a processing circuitry to execute a process, the process comprising: obtaining at least one signature for each of at least one input multimedia content element, each signature representing a concept, wherein each concept is a collection of signatures and metadata representing the concept; determining, based on the obtained signatures, at least one context of the at least one input multimedia content element; generating, based on the determined at least one context, at least one query; and searching in at least one data source using the generated at least one query.

Certain embodiments disclosed herein also include a system for searching based on input multimedia content elements. The system comprises: a processing circuitry; and a memory, the memory containing instructions that, when executed by the processing circuitry, configure the system to: obtain at least one signature for each of at least one input multimedia content element, each signature representing a concept, wherein each concept is a collection of signatures and metadata representing the concept; determine, based on the obtained signatures, at least one context of the at least one input multimedia content element; generate, based on the determined at least one context, at least one query; and search in at least one data source using the generated at least one query.

### BRIEF DESCRIPTION OF THE DRAWINGS

The subject matter that is regarded as the disclosure is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments herein.

FIG. 2 is a schematic diagram of a query generator according to an embodiment.

FIG. 3 is a flowchart illustrating a method for searching based on input multimedia content elements according to an embodiment.

FIG. 4 is a block diagram depicting the basic flow of information in the signature generator system.

FIG. 5 is a diagram showing the flow of patches generation, response vector generation, and signature generation in a large-scale speech-to-text system.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

A system and method for searching based on input multimedia content elements. At least one input multimedia content element is obtained. At least one signature is generated for each input multimedia content element. Based on the generated signatures, a query is generated. The generated query is used to search via at least one data source. Search results may be filtered. The search results are sent to, e.g., a user device.

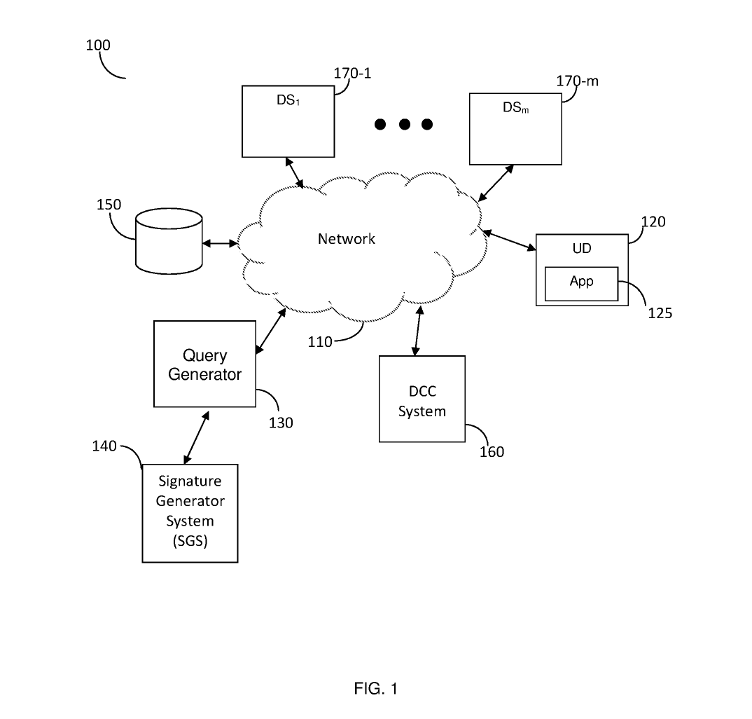

FIG. 1 is an example network diagram 100 utilized to describe the various embodiments disclosed. The network diagram 100 includes a user device 120, a query generator 130, a database 150, a deep content classification (DCC) system 160, and a plurality of data sources 170-1 through 170-m (hereinafter referred to individually as a data source 170 and collectively as data sources 170, merely for simplicity purposes) communicatively connected via a network 110. The network 110 may be, but is not limited to, the Internet, the world-wide-web (WWW), a local area network (LAN), a wide area network (WAN), a metro area network (MAN), and other networks capable of enabling communication between the elements of the network diagram 100.

The user device 120 may be, but is not limited to, a personal computer (PC), a personal digital assistant (PDA), a mobile phone, a smart phone, a tablet computer, a wearable computing device and other kinds of wired and mobile appliances, equipped with browsing, viewing, listening, filtering, managing, and other capabilities that are enabled as further discussed herein below. The user device 120 may have installed thereon an application 125 such as, but not limited to, a web browser. The application 125 may be configured to send queries and, in particular, queries including multimedia content elements. The query multimedia content elements may be, e.g., stored in a storage (not shown) of the user device 120.

The database 150 may be a context database storing information such as, but not limited to, multimedia content elements, clusters of multimedia content elements, previously determined contexts, signatures previously analyzed, a combination thereof, and the like. The database 150 may further store concepts, where the concepts may represent the previously determined contexts.

In an embodiment, the query generator 130 is communicatively connected to a signature generator system (SGS) 140, which is utilized by the query generator 130 to perform the various disclosed embodiments. Specifically, the signature generator system 140 is configured to generate signatures to multimedia content elements and includes a plurality of computational cores, each computational core having properties that are at least partially statistically independent of each other core, where the properties of each core are set independently of the properties of each other core.

The signature generator system 140 may be communicatively connected to the query generator 130 directly (as shown), or through the network 110 (not shown). In another embodiment, the query generator 130 may further include the signature generator system 140, thereby allowing the query generator 130 to generate signatures for multimedia content elements.

In an embodiment, the query generator 130 is communicatively connected to the deep content classification system 160, which is utilized by the query generator 130 to perform the various disclosed embodiments. Specifically, the deep content classification system 160 is configured to create, automatically and in an unsupervised fashion, concepts for a wide variety of multimedia content elements. To this end, the deep content classification system 160 may be configured to inter-match patterns between signatures for a plurality of multimedia content elements and to cluster the signatures based on the inter-matching. The deep content classification system 160 may be further configured to reduce the number of signatures in a cluster to a minimum that maintains matching and enables generalization to new multimedia content elements. Metadata of the multimedia content elements is collected to form, together with the reduced clusters, a concept. An example deep content classification system is described further in U.S. Pat. No. 8,266,185, assigned to the common assignee, the contents of which are hereby incorporated by reference.

The deep content classification system 160 may be communicatively connected to the query generator 130 directly (not shown), or through the network 110 (as shown). In another embodiment, the query generator 130 may further include the deep content classification system 160, thereby allowing the query generator 130 to create a concept database and to match concepts from the concept database to multimedia content elements.

In an embodiment, the query generator 130 is configured to receive, from the user device 120, an input multimedia content element to be utilized for generating a query. In another embodiment, the query generator 130 is configured to receive, from the user device 120, an indicator of a location of the input multimedia content element in a storage. In a further embodiment, the query generator 130 is configured to retrieve the multimedia content element to be tagged based on the indicator. The input multimedia content element may be, but is not limited to, an image, a graphic, a video stream, a video clip, an audio stream, an audio clip, a video frame, a photograph, an image of signals (e.g., spectrograms, phasograms, scalograms, etc.), combinations thereof, portions thereof, and the like.

In an embodiment, the query generator 130 is configured to send the input multimedia content element to the signature generator system 140, to the deep content classification system 160, or both. In a further embodiment, the query generator 130 is configured to receive a plurality of signatures generated to the multimedia content element from the signature generator system 140, to receive a plurality of signatures (e.g., signature reduced clusters) of concepts matched to the multimedia content element from the deep content classification system 160, or both. In another embodiment, the query generator 130 may be configured to generate the plurality of signatures, identify the plurality of signatures (e.g., by determining concepts associated with the signature reduced clusters matching the multimedia content element to be tagged), or a combination thereof.

Each signature represents a concept, and may be robust to noise and distortion. Each concept is a collection of signatures representing multimedia content elements and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers”. As yet another example, metadata of a concept represented by the signature generated for a picture showing a bouquet of wilted roses is “wilted flowers”.

In an embodiment, the query generator 130 is configured to correlate among the received signatures of the multimedia content element to be tagged and to determine, based on the correlation, at least one context of the multimedia content element. Each context is determined by correlating among the plurality of signatures of the multimedia content element. A context is determined as the correlation between a plurality of concepts. A strong context may be determined, e.g., when there are at least a threshold number of concepts that satisfy the same predefined condition. As a non-limiting example, by correlating a signature of a person in a baseball uniform with a signature of a baseball stadium, a context representing a “baseball player” may be determined. Correlations among the concepts of a plurality of multimedia content elements can be achieved using probabilistic models by, e.g., identifying a ratio between signatures' sizes, a spatial location of each signature, and the like. Determining contexts for multimedia content elements is described further in the above-referenced U.S. patent application Ser. No. 13/770,603.

It should be noted that using signatures for determining the context ensures more accurate queries than, for example, based on metadata or the input multimedia content element alone.

In an embodiment, the query generator 130 is configured to search contextually related search results based on the determined at least one context. To this end, in a further embodiment, the query generator 130 is configured to search through the data sources 170. The data sources 170 may include, but are not limited to, a search engine, a content provider server, a vertical comparison engine, a content publisher server, a mobile application installed on the user device, a social network, a content website, or any other storage including content to be searched.

In an embodiment, the query generator 130 is configured to generate at least one query based on the at least one input multimedia content element, where the search is performed using the at least one query. Each query may include, but is not limited to, a textual representation of the determined at least one context of the multimedia content element to be tagged. In a further embodiment, generating the query may include identifying text associated with the determined at least one context in, e.g., the database 150. In yet a further embodiment, the query generator 130 may be configured to customize each query with respect to a type of data source (e.g., a social media network, an image or video repository, a forum, etc.) or with respect to a particular data source (e.g., Facebook®, Instagram®, Twitter®, Youtube®, etc.) to which the query will be sent. The queries may be customized such that, for example, each query is in a format that is acceptable to or optimized for the data sources 170 to which the query will be sent.

In an embodiment, the query generator 130 may be configured to determine a portion of each input multimedia content element to be utilized for generation of search queries. In a further embodiment, the query generator 130 may be configured to cause a display of one or more potential portions of the input multimedia content elements on the user device 120, and to determine which portions to utilize for searching based on selections made by a user of the user device 120. As a non-limiting example, to provide appropriate search results for sunglasses of a particular brand shown in an input image, the user of the user device 120 may be presented with portions of the multimedia content element, and may select one or more of the portions to be searched.

In an embodiment, the query generator 130 is configured to generate the at least one query by identifying concepts matching the determined at least one context (e.g., concepts stored in the database 150 that represent previously determined contexts), where the textual representation of the context includes text of metadata of the identified concepts (i.e., metadata representing the identified concepts). In a further embodiment, the query generator 130 is configured to search the database 150 for previously determined contexts matching the determined at least one context of the multimedia content element to be tagged, where the identified concepts represent the matching contexts.

In an embodiment, the query generator 130 may be configured to optimize the generated at least one query based on parameters related to the user device 120 such as, but not limited to, data indicating user behavior, demographic information, and the like. As a non-limiting example, if the input multimedia content element is a picture showing a BMW X3 model car and parameters related to the user device 120 incicates user behavior suggesting the user is looking to buy a car and that the user is located in the bay area, the generated at least one query may include “BMW X3 model” and may further be optimized to include “BMW X3 model car dealerships bay area” based on the additional parameters.

In a further embodiment, the query generator 130 may be configured to filter the obtained search results. The filtering may include, but is not limited to, matching signatures generated for multimedia content elements among the search results to the signatures generated for the input multimedia content elements, wherein only search results including multimedia content elements matching signatures of at least one of the input multimedia content elements above a predetermined threshold.

In an embodiment, the query generator 130 is configured to send the search results to, e.g., the user device 120. The user device 120 may be configured to display the search results.

It should be noted that only one user device 120 and one application 125 are described herein above with reference to FIG. 1 merely for the sake of simplicity and without limitation on the disclosed embodiments. Multiple user devices may provide multimedia content elements via multiple applications 125, and tags for each multimedia content element may be recommended to the sending user device, without departing from the scope of the disclosure.

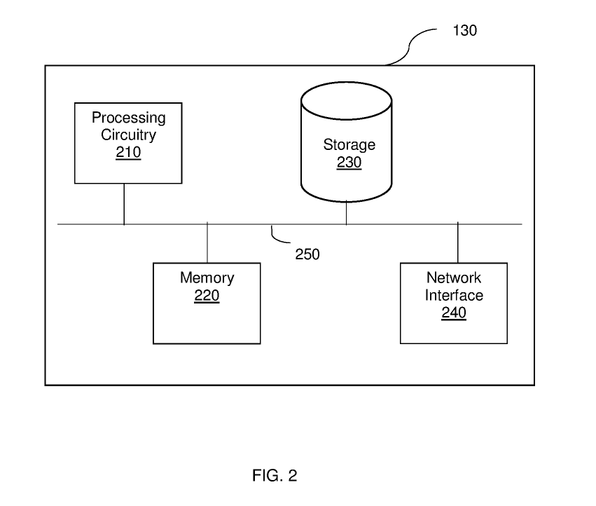

FIG. 2 is an example schematic diagram 200 of a query generator 130 according to an embodiment. The query generator 130 includes a processing circuitry 210 coupled to a memory 220, a storage 230, and a network interface 240. In an embodiment, the components of the trending content recommendation generator 130 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), general-purpose microprocessors, microcontrollers, digital signal processors (DSPs), and the like, or any other hardware logic components that can perform calculations or other manipulations of information. In an embodiment, the processing circuitry 210 may be realized as an array of at least partially statistically independent computational cores. The properties of each computational core are set independently of those of each other core, as described further herein above.

The memory 220 may be volatile (e.g., RAM, etc.), non-volatile (e.g., ROM, flash memory, etc.), or a combination thereof. In one configuration, computer readable instructions to implement one or more embodiments disclosed herein may be stored in the storage 230.

In another embodiment, the memory 220 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 210, cause the processing circuitry 210 to perform the various processes described herein. Specifically, the instructions, when executed, cause the processing circuitry 210 to search based on input multimedia content elements as described herein.

The storage 230 may be magnetic storage, optical storage, and the like, and may be realized, for example, as flash memory or other memory technology, CD-ROM, Digital Versatile Disks (DVDs), or any other medium which can be used to store the desired information.

The network interface 240 allows the queery generator 130 to communicate with the signature generator system 140 for the purpose of, for example, sending multimedia content elements, receiving signatures, and the like. Further, the network interface 240 allows the query generator 130 to receive input multimedia content elements from the user device 120, to send search results to the user device 120, to send queries to the data sources 170, to receive search results from the data sources 170, and the like.

It should be understood that the embodiments described herein are not limited to the specific architecture illustrated in FIG. 2, and other architectures may be equally used without departing from the scope of the disclosed embodiments. In particular, the query generator 130 may further include a signature generator system configured to generate signatures as described herein without departing from the scope of the disclosed embodiments.

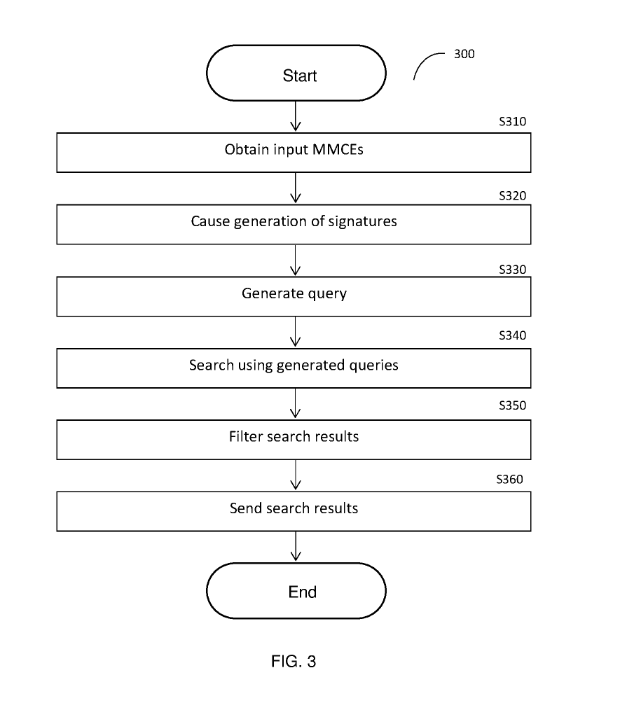

FIG. 3 depicts an example flowchart 300 illustrating a method for searching based on input multimedia content elements according to an embodiment. In an embodiment, the method may be performed by the query generator 130.

At S310, at least one input multimedia content element is obtained. In an embodiment, S310 may include receiving a request including the multimedia content element to be tagged. The request may further include one or more potential tags received from a user device. The request may be received by the agent 125 installed on the user device 120. In another embodiment, S310 may include receiving a pointer to the at least one input multimedia content element in a storage and retrieving the at least one input multimedia content element at the storage location.

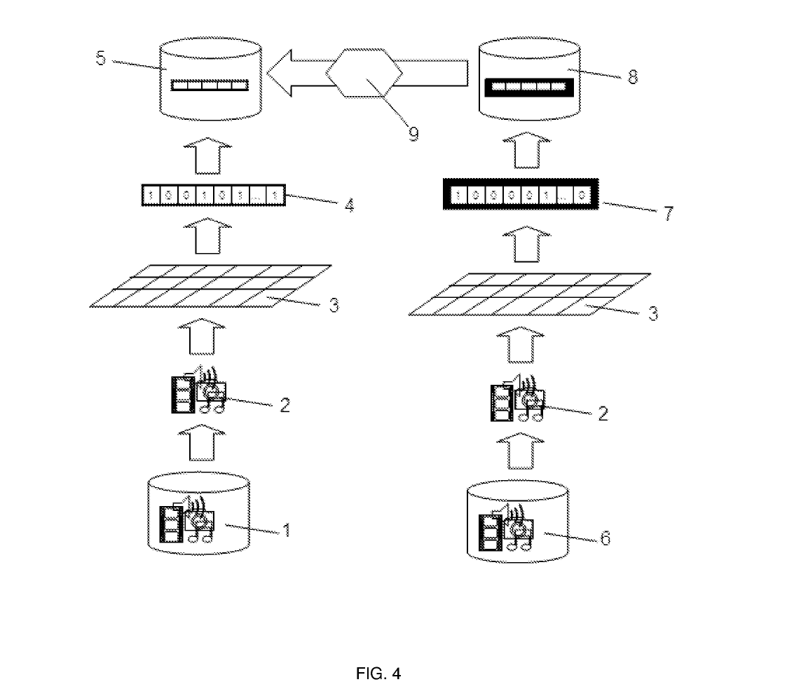

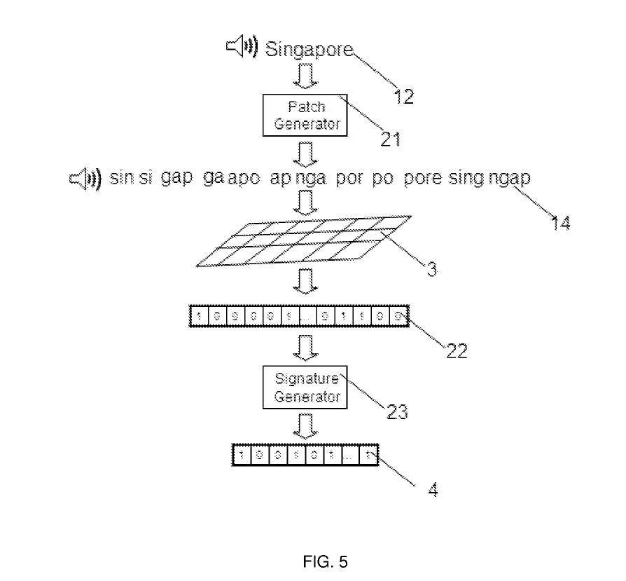

At S320, at least one signature is caused to be generated for each of the at least one input multimedia content element. The signatures are generated as described below with respect to FIGS. 4 and 5. The signatures may be robust to noise and distortion.

In an embodiment, S320 includes generating the signatures via a plurality of at least partially statistically independent computational cores, where the properties of each core are set independently of the properties of the other cores. In another embodiment, S320 includes sending the multimedia content element to a signature generator system, to a deep content classification system, or both, and receiving the plurality of signatures. The signature generator system includes a plurality of at least statistically independent computational cores as described further herein. The deep content classification system is configured to create concepts for a wide variety of multimedia content elements, automatically and in an unsupervised fashion.

At S330, a query is generated based on the generated signatures. In an embodiment, S330 includes correlating between concepts of the signatures and determining, based on the correlations, at least one context of the multimedia content element. In a further embodiment, S330 also includes searching for textual representations of the determined contexts. In another embodiment, S330 may include optimizing the query based on at least one parameter related to, e.g., a user device from which the input multimedia content element was received.

In yet another embodiment, each query may be optimized for sending to a particular data source. As a non-limiting example, the queries may be optimized such that different queries are generated for each input multimedia content element with respect to different data sources. As a non-limiting example, for an input video, a first query may be generated that is optimized for sending to the Facebook® web site and a second query may be generated that is optimized for sending to the Google® search engine.

At S340, a search is performed using the generated query. The search may include, but is not limited to, sending the generated at least one query to at least one data source and receiving search results from each data source. In an embodiment, different queries may be sent to different data sources.

At optional S350, the search results may be filtered. In an embodiment, the filtering may include causing generation of signatures to multimedia content elements among the search results and comparing the generated search result signatures to the generated input multimedia content element signatures. In a further embodiment, search results including multimedia content elements having signatures matching one or more of the input multimedia content element signatures below a predetermined threshold may be filtered out.

At S360, the search results are sent to, e.g., a user device from which the input multimedia content element is received. The user device is configured to display the search results.

FIGS. 4 and 5 illustrate the generation of signatures for the multimedia content elements by the SGS 140 according to an embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 5. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame 1′ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

Vᵢ=Σwᵢⱼk,

nᵢ=θ(Vi−Thₓ)

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thₓ are set differently for Signature generation and for Robust Signature generation. For example, for a certain distribution of Vi values (for the set of nodes), the thresholds for Signature (Thₛ) and Robust Signature (Th_{RS}) are set apart, after optimization, according to at least one or more of the following criteria:
1: For: Vᵢ>Th_{RS}

1−p(V>Thₛ)−1−(1−ε)¹>>1

i.e., given that l nodes (cores) constitute a Robust Signature of a certain image I, the probability that not all of these I nodes will belong to the Signature of same, but noisy image, Ĩ is sufficiently low (according to a system's specified accuracy).
2: p(Vᵢ>Th_{RS})≈l/L
   i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. Nos. 8,326,775 and 8,312,031, assigned to the common assignee, which are hereby incorporated by reference.

A Computational Core generation is a process of definition, selection, and tuning of the parameters of the cores for a certain realization in a specific system and application. The process is based on several design considerations, such as:
(a) The Cores should be designed so as to obtain maximal independence, i.e., the projection from a signal space should generate a maximal pair-wise distance between any two cores' projections into a high-dimensional space.
(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.
(c) The Cores should be optimally designed with regard to invariance to a set of signal distortions, of interest in relevant applications.

A detailed description of the Computational Core generation and the process for configuring such cores is discussed in more detail in U.S. Pat. No. 8,655,801 referenced above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the disclosed embodiments and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

What is claimed is:

1. A method for searching based on input multimedia content elements, comprising:
obtaining at least one signature for each of at least one input multimedia content element, each signature representing a concept, wherein each concept is a collection of signatures and metadata representing the concept;
determining, based on the obtained signatures, at least one context of the at least one input multimedia content element;
generating, based on the determined at least one context, at least one query; and
searching in at least one data source using the generated at least one query.

2. The method of claim 1, wherein the at least one query includes a textual representation of the at least one context.

3. The method of claim 1, wherein searching in the at least one data source further comprises:
sending, to each data source, at least one of the at least one query; and
obtaining, from each data source, search results.

4. The method of claim 1, wherein determining the at least one context:
correlating between at least a portion of the concepts of the obtained signatures, wherein the at least one context is determined based on the correlation.

5. The method of claim 1, further comprising:
optimizing each generated query with respect to at least one of the at least one data source.

6. The method of claim 1, further comprising:
filtering the search results based on at least one parameter related to a user device.

7. The method of claim 1, wherein obtaining the plurality of signatures further comprises:
sending, to a deep content classification system, the at least one input multimedia content element, wherein the deep content classification system is configured to create concepts for a wide variety of multimedia content elements; and
receiving, from the deep content classification system, the at least one signature for the at least one input multimedia content element, wherein the plurality of signatures includes signature reduced clusters representing concepts related to the multimedia content element to be tagged.

8. The method of claim 1, wherein each signature is generated by a signature generator system, wherein the signature generator system includes a plurality of at least partially statistically independent computational cores, wherein the properties of each core are set independently of the properties of each other core.

9. The method of claim 8, wherein obtaining the at least one signature for the at least one input multimedia content element further comprises:
obtaining the at least one input multimedia content element; and
generating, by the signature generator system, the at least one signature for each input multimedia content element.

10. A non-transitory computer readable medium having stored thereon instructions for causing a processing circuitry to execute a process, the process comprising:
obtaining at least one signature for each of at least one input multimedia content element, each signature representing a concept, wherein each concept is a collection of signatures and metadata representing the concept;
determining, based on the obtained signatures, at least one context of the at least one input multimedia content element;
generating, based on the determined at least one context, at least one query; and
searching in at least one data source using the generated at least one query.

11. A system for recommending tags for a multimedia content element to be tagged, comprising:
a processing circuitry; and
a memory connected to the processing circuitry, the memory containing instructions that, when executed by the processing circuitry, configure the system to:
obtain at least one signature for each of at least one input multimedia content element, each signature representing a concept, wherein each concept is a collection of signatures and metadata representing the concept;
determine, based on the obtained signatures, at least one context of the at least one input multimedia content element;
generate, based on the determined at least one context, at least one query; and
search in at least one data source using the generated at least one query.

12. The system of claim 11, wherein the at least one query includes a textual representation of the at least one context.

13. The system of claim 11, wherein the system is further configured to:
send, to each data source, at least one of the at least one query; and
obtain, from each data source, search results.

14. The system of claim 11, wherein the system is further configured to:
correlate between at least a portion of the concepts of the obtained signatures, wherein the at least one context is determined based on the correlation.

15. The system of claim 11, wherein the system is further configured to:
optimize each generated query with respect to at least one of the at least one data source.

16. The system of claim 11, wherein the system is further configured to:
filter the search results based on at least one parameter related to a user device.

17. The system of claim 11, wherein the system is further configured to:
send, to a deep content classification system, the at least one input multimedia content element, wherein the deep content classification system is configured to create concepts for a wide variety of multimedia content elements; and
receive, from the deep content classification system, the at least one signature for the at least one input multimedia content element, wherein the plurality of signatures includes signature reduced clusters representing concepts related to the multimedia content element to be tagged.

18. The system of claim 11, wherein each signature is generated by a signature generator system, wherein the signature generator system includes a plurality of at least partially statistically independent computational cores, wherein the properties of each core are set independently of the properties of each other core.

19. The system of claim 18, wherein the system is further configured to:
obtain the at least one input multimedia content element; and
generate, by the signature generator system, the at least one signature for each input multimedia content element.

20. The system of claim 11, further comprising:
a signature generator system for generating the at least one signature for the at least one input multimedia content element, wherein the signature generator system includes a plurality of computational cores configured to receive a plurality of unstructured data elements, each computational core of the plurality of computational cores having properties that are at least partly statistically independent of other of the computational cores, the properties are set independently of each other core.
